(19) United States
(12) Patent Application Publication
(10) Pub. No.: US 2016/0306404 A1
(43) Pub. Date: Oct. 20, 2016

(54) LIMITING IN-RUSH CURRENT FOR PLUG-IN CAPACITIVE LOADS

(71) Applicant: Apple Inc., Cupertino, CA (US)

(72) Inventors: Jose V. SANTOS Martinez, Santa Clara, CA (US); Collin E. Connors, Sunnyvale, CA (US); Yongxuan Hu, San Jose, CA (US)

(21) Appl. No.: 14/686,360

(22) Filed: Apr. 14, 2015

(51) Int. Cl. G06F 1/26; G06F 13/38; G06F 13/42; G06F 1/32; G06F 13/40

(52) U.S. Cl. CPC G06F 1/266; G06F 1/3287; G06F 13/4022; G06F 13/4282; G06F 13/385; G06F 1/325

(57) ABSTRACT

A circuit for limiting an in-rush current for devices coupling to a capacitive load may include a port configured to receive a device and a first capacitor coupled to the port. Additionally, the circuit may include a first resistor coupled in series with the first capacitor and a switch coupled in parallel with the first resistor. The switch is configured to close after an in-rush current event has passed, thereby bypassing the first resistor from the circuit and enabling the first capacitor to effectively filter noise from the voltage output to the port.

### BACKGROUND

The present disclosure relates generally to computing devices that include input/output (I/O) ports. More specifically, the present disclosure relates to systems and methods for limiting an in-rush current that may be output via an I/O port of a computing device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Over the years, certain technology, such as Universal Serial Bus (USB) technology, has commonly been used to transfer data between two computing devices. In addition to transferring data, USB technology has also been capable of outputting a limited amount of power to USB devices via a USB port. As more users rely on USB ports to provide power for their USB devices, USB ports are now designed to provide increased power output to meet this increased demand

In recent years, a USB Power Delivery (PD) specification has called for providing more flexible power delivery, as well as data transmission, over a single cable. In addition to providing more flexible power deliver (e.g., increased power output), the USB PD specification aims at operating within the existing USB ecosystem, which includes USB 1.x, 2.0, 3.0, and 3.1 devices with A, B, and C-type connections. For example, the USB PD specification includes a power output capability of 100 watts with up to 5 amps of current. To effectively provide power output signals at these higher power levels, devices that output these elevated amounts of power may use a certain amount of input capacitance (e.g., greater than 10 μF) to improve the quality of a voltage signal output to other devices. For instance, USB ports disposed on various types of computing devices may use a certain amount of capacitance to filter alternating current (AC) noise from direct current (DC) voltage signals output to connected USB devices. However, when certain types of USB devices are coupled to the USB port, the input capacitance of the USB port may cause a certain amount of in-rush current (e.g., greater than 100 mA) to be output to the connected USB device when the USB device is initially coupled to the USB port. In some cases, the in-rush current associated with the input capacitance may exceed maximum load properties specified for the connected USB device or the cable coupling the USB device to the USB port. As such, although the increased power capabilities provided by the USB PD specification should allow users to have more flexible access to power sources to power various types of devices, older USB devices may not be equipped to receive such levels of power.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

As discussed above, the Universal Serial Bus Power Delivery (USB PD) specification calls for providing higher amounts of power (e.g., 100 watts) via a USB port, as compared to previous USB specifications (e.g., 4.5 watts for USB 3.0). However, often times, outputting these elevated amounts of power via the USB port may also include outputting a certain amount of in-rush current (e.g., greater than 100 mA) to a USB device when the USB device is initially coupled to the USB port. In some cases, the in-rush current associated with the input capacitance may exceed maximum load properties specified for the connected USB device or the cable coupling the USB device to the USB port, and thus may damage the USB device, the cable, or both.

To address these problems, a current limiting circuit may be coupled to the input capacitance of the USB port to limit the in-rush current that may be output to the connected USB device. For example, a current-limiting resistor may be coupled in series with the input capacitance to limit the amount of in-rush current output to the USB device. In addition to the current limiting resistor, a switch may be coupled in parallel with the current-limiting resistor to allow current to bypass the current-limiting resistor after the in-rush current has passed. As such, the switch may be open during the in-rush current event and closed after the in-rush current event has passed. After the switch is closed and the current bypasses the current-limiting resistor via the switch, the input capacitance may again filter AC noise from the DC voltage signal output by the USB port. By including the circuitry to limit the in-rush current present at the USB port while maintaining the presence of the input capacitance, the USB port may output power that may induce in-rush currents that exceed the specifications of older USB devices without causing damage to these devices. Moreover, since the current-limiting resistor is effectively removed from the circuit after the in-rush current event has passed, the input capacitance may still be utilized to provide filtered voltage signals to connected devices.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a simplified block diagram of components of an electronic device that may output power to connected devices, in accordance with embodiments described herein;

FIG. 2 is a perspective view of the electronic device of FIG. 1 in the form of a notebook computing device, in accordance with embodiments described herein;

FIG. 3 is a front view of the electronic device of FIG. 1 in the form of a desktop computing device, in accordance with embodiments described herein;

FIG. 4 is a front view of the electronic device of FIG. 1 in the form of a handheld portable electronic device, in accordance with embodiments described herein;

FIG. 5 is a front view of the electronic device of FIG. 1 in the form of a tablet computing device, in accordance with embodiments described herein;

FIG. 6 is a schematic diagram of a current-limiting circuit that may be integrated into input/output (I/O) ports of the electronic device of FIG. 1, in accordance with embodiments described herein;

FIG. 7 is a collection of graphs that simulate the operation of certain components of the current-limiting circuit of FIG. 6, in accordance with embodiments described herein;

FIG. 8 is a schematic diagram of the current-limiting circuit of FIG. 6 with a voltage divider and power dissipating diodes, in accordance with embodiments described herein;

FIG. 9 is a schematic diagram of an alternate configuration of the current-limiting circuit of FIG. 6, in accordance with embodiments described herein; and

FIG. 10 is a flow chart of a method for limiting an in-rush current for capacitive loads, in accordance with embodiments described herein.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “embodiments” of the present disclosure are not intended to be interpreted as excluding the existence of additional embodiments that also incorporate the recited features.

As discussed above, the Universal Serial Bus Power Delivery (USB PD) specification provides that power up to 100 watts may be delivered or output via a USB port for various devices capable of coupling to the USB port. However, certain types of USB devices (e.g., USB 1.0) may not be designed to receive the amount of in-rush current that may be provided based on an input capacitance at the USB port when the USB device is initially connected to the USB port. That is, this in-rush current may cause damage to the connected USB device or to the cable connecting the USB device to the USB port.

With the foregoing in mind, a current-limiting resistor may be coupled in series with the input capacitance of a USB port to limit the amount of in-rush current provided to a connected USB device. In addition to the current limiting resistor, a switch, such as a MOSFET transistor, may be coupled parallel with the current-limiting resistor to allow current to bypass the current-limiting resistor after the in-rush current has passed. To ensure that the switch is closed after the in-rush current event has passed, the gate of the transistor may be coupled to a resistor-capacitor (RC) filter that may be designed to provide the gate with a threshold voltage when the in-rush current is expected to have passed. As such, the switch will close after the in-rush current event, thus allowing the remaining current to bypass the current-limiting resistor via the switch. As a result, the in-rush current output via the USB port may be limited to a specified value based on the value of the current-limiting resistance. Moreover, the input capacitor at the USB port may still be employed to remove AC noise from a DC voltage signal output by the USB port after the in-rush current event has passed, thereby maintaining a quality of the power signal output by the USB port.

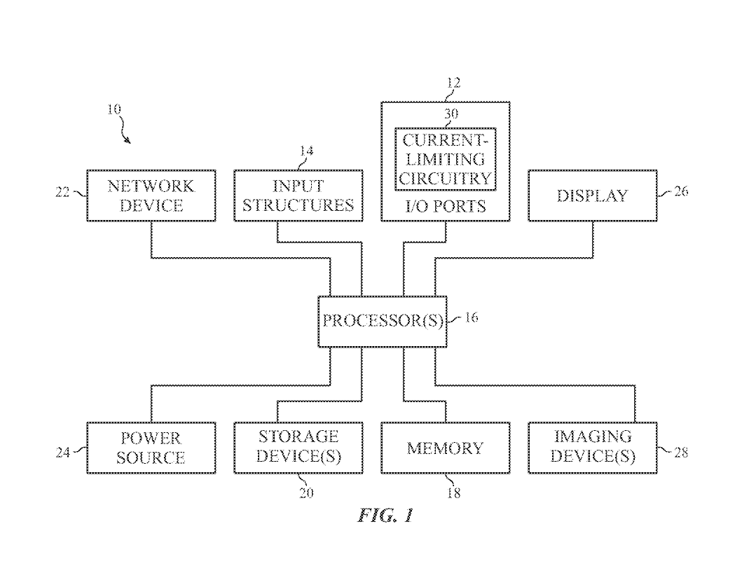

By way of introduction, FIG. 1 is a block diagram illustrating an example of an electronic device 10 that may include the current-limiting circuitry mentioned above. The electronic device 10 may be any suitable electronic device, such as a laptop or desktop computer, a mobile phone, a digital media player, or the like. By way of example, the electronic device 10 may be a portable electronic device, such as a model of an iPod® or iPhone®, available from Apple Inc. of Cupertino, California. The electronic device 10 may be a desktop or notebook computer, such as a model of a MacBook®, MacBook® Pro, MacBook Air®, iMac®, Mac® Mini, or Mac Pro®, available from Apple Inc. In other embodiments, electronic device 10 may be a model of an electronic device from another manufacturer.

As shown in FIG. 1, the electronic device 10 may include various components. The functional blocks shown in FIG. 1 may represent hardware elements (including circuitry), software elements (including code stored on a computer-readable medium) or a combination of both hardware and software elements. In the example of FIG. 1, the electronic device 10 includes input/output (I/O) ports 12, input structures 14, one or more processors 16, a memory 18, nonvolatile storage 20, networking device 22, power source 24, display 26, and one or more imaging devices 28. It should be appreciated, however, that the components illustrated in FIG. 1 are provided only as an example. Other embodiments of the electronic device 10 may include more or fewer components. To provide one example, some embodiments of the electronic device 10 may not include the imaging device(s) 28.

Before continuing further, it should be noted that the system block diagram of the device 10 shown in FIG. 1 is intended to be a high-level control diagram depicting various components that may be included in such a device 10. That is, the connection lines between each individual component shown in FIG. 1 may not necessarily represent paths or directions through which data flows or is transmitted between various components of the device 10. Indeed, as discussed below, the depicted processor(s) 16 may, in some embodiments, include multiple processors, such as a main processor (e.g., CPU), and dedicated image and/or video processors. In such embodiments, the processing of image data may be primarily handled by these dedicated processors, thus effectively offloading such tasks from a main processor (CPU).

Considering each of the components of FIG. 1, the I/O ports 12 may represent ports to connect to a variety of devices, such as a power source, an audio output device, or other electronic devices. For example, the I/O ports 12 may connect to an external device, such as a digital camera, a digital audio player, a memory component, or the like. In one embodiment, the I/O ports 12 may include a Universal Serial Bus (USB) port that enables the electronic device 10 to exchange data between itself and a connected device. In addition to providing data services, the USB port may output a certain amount of voltage (e.g., 20 volts), current (e.g., 5 amps), and power (e.g., 100 watts). As such, devices connected to the USB port may receive power that may be used to charge the respective device, amplify sounds from the respective device, or for any other suitable function.

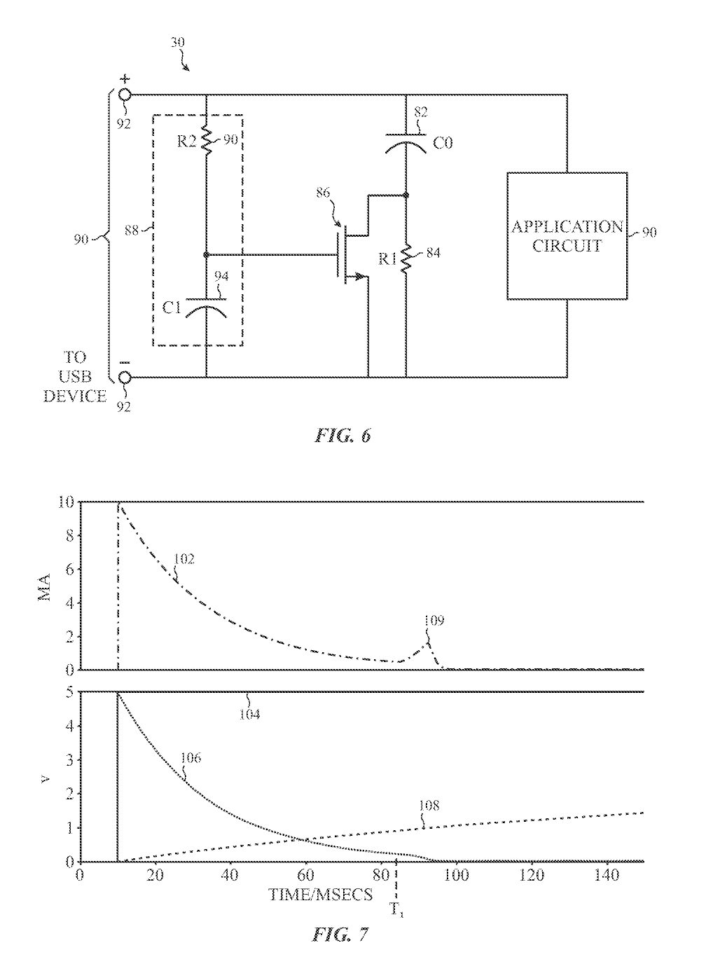

In one embodiment, one or more of the I/O ports 12 may include current-limiting circuitry 30, as discussed above. Additional details regarding the current-limiting circuitry 30 and the manner in which it may reduce the amount of in-rush current received by a device connected to the I/O ports 12 will be discussed with reference to FIGS. 6-10 below.

The input structures 14 may enable user input to the electronic device, and may include hardware keys, a touch-sensitive element of the display 28, and/or a microphone. The processor(s) 16 may control the general operation of the device 10. For instance, the processor(s) 16 may execute an operating system, programs, user and application interfaces, and other functions of the electronic device 10. The processor(s) 16 may include one or more microprocessors and/or application-specific microprocessors (ASICs), or a combination of such processing components. For example, the processor(s) 16 may include one or more instruction set (e.g., RISC) processors, as well as graphics processors (GPU), video processors, audio processors and/or related chip sets. As may be appreciated, the processor(s) 16 may be coupled to one or more data buses for transferring data and instructions between various components of the device 10. In certain embodiments, the processor(s) 16 may provide the processing capability to execute an imaging applications on the electronic device 10, such as Photo Booth®, Aperture®, iPhoto®, Preview®, iMovie®, or Final Cut Pro® available from Apple Inc., or the “Camera” and/or “Photo” applications provided by Apple Inc. and available on some models of the iPhone®, iPod®, and iPad®.

A computer-readable medium, such as the memory 18 or the nonvolatile storage 20, may store the instructions or data to be processed by the processor(s) 16. The memory 18 may include any suitable memory device, such as random access memory (RAM) or read only memory (ROM). The nonvolatile storage 20 may include flash memory, a hard drive, or any other optical, magnetic, and/or solid-state storage media. The memory 18 and/or the nonvolatile storage 20 may store firmware, data files, image data, software programs and applications, and so forth.

The network device 22 may be a network controller or a network interface card (NIC), and may enable network communication over a local area network (LAN) (e.g., Wi-Fi), a personal area network (e.g., Bluetooth), and/or a wide area network (WAN) (e.g., a 3G or 4G data network). The power source 28 of the device 10 may include a Li-ion battery and/or a power supply unit (PSU) to draw power from an electrical outlet or an alternating-current (AC) power supply.

The display 26 may display various images generated by device 10, such as a GUI for an operating system or image data (including still images and video data). The display 26 may be any suitable type of display, such as a liquid crystal display (LCD), plasma display, or an organic light emitting diode (OLED) display, for example. Additionally, as mentioned above, the display 26 may include a touch-sensitive element that may represent an input structure 14 of the electronic device 10. The imaging device(s) 28 of the electronic device 10 may represent a digital camera that may acquire both still images and video. Each imaging device 28 may include a lens and an image sensor capture and convert light into electrical signals.

As mentioned above, the electronic device 10 may take any number of suitable forms. Some examples of these possible forms appear in FIGS. 2-5. Turning to FIG. 2, a notebook computer 40 may include a housing 42, the display 28, the I/O ports 12, and the input structures 14. The input structures 14 may include a keyboard and a touchpad mouse that are integrated with the housing 42. Additionally, the input structure 14 may include various other buttons and/or switches which may be used to interact with the computer 40, such as to power on or start the computer, to operate a GUI or an application running on the computer 40, as well as adjust various other aspects relating to operation of the computer 40 (e.g., sound volume, display brightness, etc.). The computer 40 may also include various I/O ports 12 that provide for connectivity to additional devices, as discussed above, such as a FireWire® or USB port, a high definition multimedia interface (HDMI) port, or any other type of port that is suitable for connecting to an external device. Additionally, the computer 40 may include network connectivity (e.g., network device 24), memory (e.g., memory 18), and storage capabilities (e.g., storage device 20), as described above with respect to FIG. 1.

The notebook computer 40 may include an integrated imaging device 28 (e.g., a camera). In other embodiments, the notebook computer 40 may use an external camera (e.g., an external USB camera or a “webcam”) connected to one or more of the I/O ports 12 instead of or in addition to the integrated imaging device 28. In certain embodiments, the depicted notebook computer 40 may be a model of a MacBook®, MacBook® Pro, MacBook Air®, or PowerBook® available from Apple Inc. In other embodiments, the computer 40 may be portable tablet computing device, such as a model of an iPad® from Apple Inc.

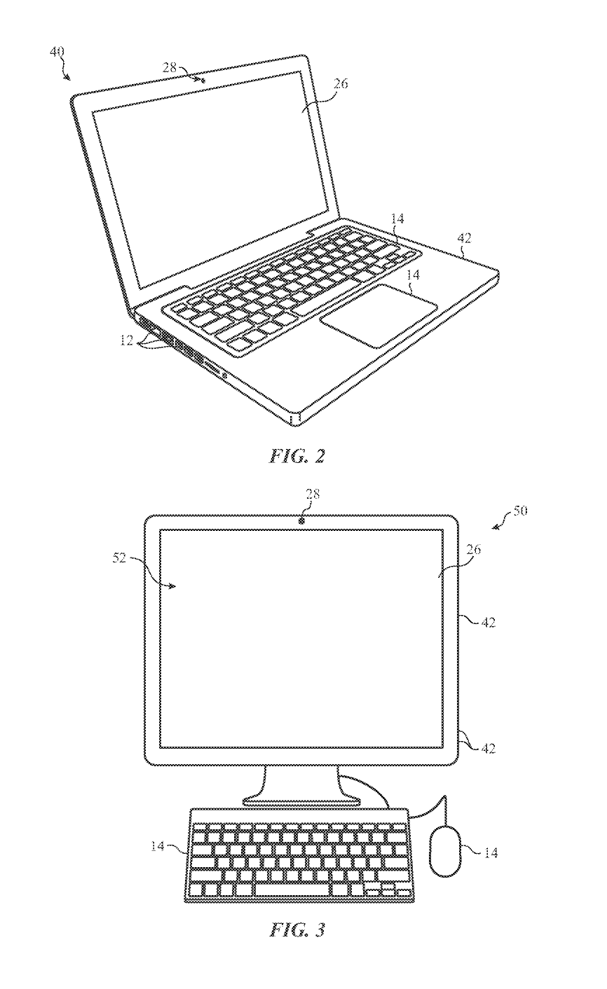

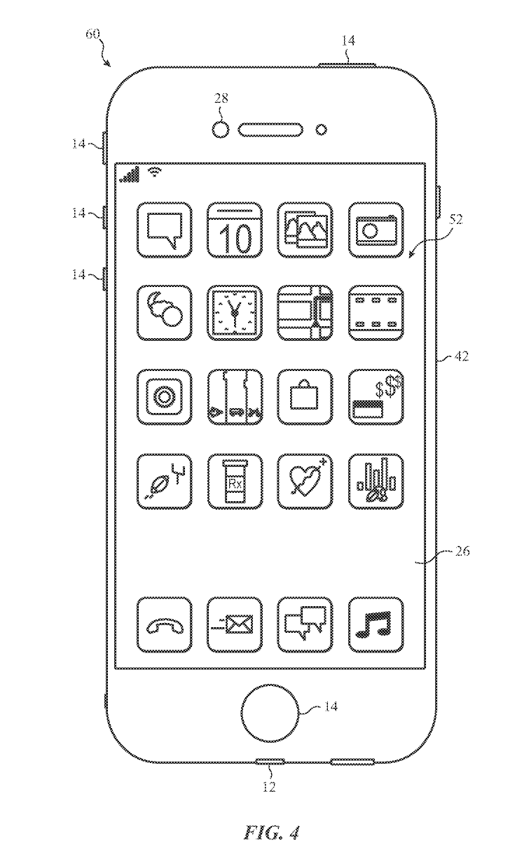

FIG. 3 shows the electronic device 10 in the form of a desktop computer 50. The desktop computer 50 may include a number of features that may be generally similar to those provided by the notebook computer 40 shown in FIG. 4, but may have a generally larger overall form factor. As shown, the desktop computer 50 may be housed in an enclosure 42 that includes the display 26, as well as various other components discussed above with regard to the block diagram shown in FIG. 1. Further, the desktop computer 50 may include an external keyboard and mouse (input structures 14) that may be coupled to the computer 50 via one or more I/O ports 12 (e.g., USB) or may communicate with the computer 50 wirelessly (e.g., RF, Bluetooth, etc.). The desktop computer 50 also includes an imaging device 28, which may be an integrated or external camera, as discussed above. In certain embodiments, the depicted desktop computer 50 may be a model of an iMac®, Mac® mini, or Mac Pro®, available from Apple Inc.

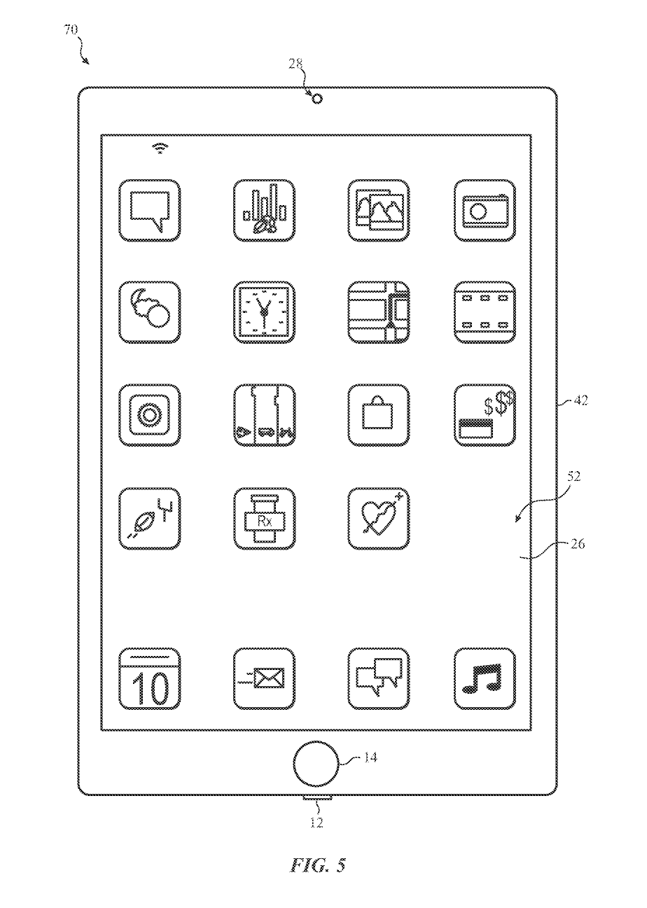

The electronic device 10 may also take the form of portable handheld device 60 or 70, as shown in FIGS. 4 and 5. By way of example, the handheld device 60 or 70 may be a model of an iPod® or iPhone® available from Apple Inc. The handheld device 60 or 70 includes an enclosure 42, which may function to protect the interior components from physical damage and to shield them from electromagnetic interference. The enclosure 42 also includes various user input structures 14 through which a user may interface with the handheld device 60 or 70. Each input structure 14 may control various device functions when pressed or actuated. As shown in FIGS. 4 and 5, the handheld device 60 or 70 may also include various I/O ports 12. For instance, the depicted I/O ports 12 may include a proprietary connection port for transmitting and receiving data files or for charging a power source 24. Further, the I/O ports 12 may also be used to output voltage, current, and power to other connected devices.

The display device 26 may display images generated by the handheld device 60 or 70. For example, the display 26 may display system indicators that may indicate device power status, signal strength, external device connections, and so forth. The display 28 may also display a GUI 52 that allows a user to interact with the device 60 or 70, as discussed above with reference to FIG. 3. The GUI 52 may include graphical elements, such as the icons, which may correspond to various applications that may be opened or executed upon detecting a user selection of a respective icon.

Having provided some context with regard to possible forms that the electronic device 10 may take, the present discussion will now focus on the current-limiting circuitry 30 shown in FIG. 1. As mentioned above, to filter noise that may be associated with the power output via the I/O ports 12, the I/O ports 12 may include a capacitor that may filter or remove at least some alternating current (AC) noise from a direct current (DC) voltage output via the I/O ports 12. However, in certain power applications, the size (i.e., capacitance) of the capacitor used to filter the power output via I/O ports 12 may be too large of a capacitive load for certain types of devices or cables to connect to without risking an in-rush current that may potentially damage the connected device or cable. That is, certain device and power delivery cables (e.g., USB Type-C) may have maximum load capabilities that may be exceeded when they are initially connected to a power supply.

With the foregoing in mind, FIG. 6 illustrates a schematic diagram of one embodiment related to the current-limiting circuitry 30 described above. As such, the current-limiting circuit 30 of FIG. 6 may reduce an amount of current output via the I/O port 12. As shown in FIG. 6, the current-limiting circuitry 30 may include a filtering capacitor 82, a current-limiting resistor 84, a bypass switch 86, a resistor-capacitor (RC) circuit 88, and an application circuit 90. In certain embodiments, the application circuit 90 may include a generic power circuit (e.g., high frequency DC-DC converter) that may provide power or voltage to nodes 92 of the I/O port 12. As such, the application circuit 90 may include a rectifier circuit, a DC-DC converter, or the like. Generally, the capacitor 82 may be used to filter or shunt AC noise that may be output via the application circuit 90, to reduce fluctuations of power or voltage output via the application circuit 90 due to switching that may be occurring in the application circuit 90, and the like.

For certain power applications (e.g., as may be specified by the USB PD specification), when certain versions of USB devices (e.g., USB 1.0 or 2.0 devices or cables) connect to the electrical nodes 92, the in-rush current provided to the connected USB devices due to the capacitance of the capacitor 82 may exceed the respective specifications of the connected USB devices. That is, with increased power being provided via the electrical nodes 92 as compared to previous versions of USB ports, the capacitance of the capacitor 82 may be larger than used in previous USB port circuitry. This increased capacitance may enable the current-limiting circuitry 30 to filter additional noise due to the increase power output and improve the quality of the power being output via the electrical nodes 90. However, along with the improved filtering ability provided by the larger capacitor 82, the capacitor 82 may also store more energy as compared to capacitors used in previous versions of the USB ports. As such, when devices are coupled to the electrical nodes 92, the connected devices may be subject to more in-rush current from the stored energy of the capacitor 82 as compared to the smaller capacitors used in the previous versions of the USB ports. Since some versions of USB devices are not designed receive these increased amounts of current (e.g., 5 amps) that may be induced by the capacitor 82, these USB devices may be damaged when connected to the electrical nodes 92 having the capacitor 82 and the application circuit 90.

With the foregoing in mind, the current-limiting circuitry 30 may limit the amount of capacitive load that a device connected to the I/O port 12 may be exposed to when initially connecting to the I/O port 12 (e.g., plugging into the I/O port 12). In other words, the current-limiting circuitry 30 may limit the initial current output via the capacitor 82 for a period of time until the stored energy of the capacitor 82 has been dissipated. After the excess charge of the capacitor 82 has been dissipated, the current-limiting circuitry 30 may cease operation, such that the capacitor 82 may perform its designed function of filtering the output of the application circuit 90. As a result, the capacitor 82 may be employed to improve the quality of power or voltage output via the application circuit 90 while the in-rush current received by a device connected to the I/O port 12 may be limited when necessary.

To limit the in-rush current received by the connected device, the current-limiting resistor 84 may be coupled in series with the capacitor 82 as shown in FIG. 6. As such, the resistance of the current-limiting resistor 84 may be determined based on the capacitance of the capacitor 82, the voltage output via the application circuit 90, and some maximum current value. In one example, the maximum current value may be associated with the lowest current rating of existing USB devices (e.g., as set forth in the specifications for USB 1.0, USB 2.0, USB 3.0, USB 3.1, etc.). That is, the maximum current value may be determined to be the worst-case in-rush current limit for existing USB devices. As such, the maximum current value may be, in one example, 100 mA associated with USB 1.0 devices. With this in mind, the resistance of the current-limiting resistor 84 may be determined based on the capacitance of the capacitor 82, the voltage output via the application circuit 90, and the 100 mA maximum current value. That is, the current-limiting resistor 84 may limit the current output by the capacitor 82 to the desired maximum current value or less than the desired maximum current value when the application circuit 90 provides the voltage output across the capacitor 82.

Also, it should be noted that in some embodiments, the application circuit 90 may be capable of outputting different voltages. In this case, the resistance value of the current-limiting resistor 84 may be determined using the largest voltage output capable of being output by the application circuit 90. As such, the in-rush current output via the capacitor 82 may still be limited to prevent damage from occurring on any device connected to electrical nodes 92.

Referring back to FIG. 6, the switch 86 that is parallel with the current-limiting resistor 84 may provide a conduction path for current in series with the capacitor 82 that may avoid the current-limiting resistor 84. In the depicted embodiment, the switch 86 may be an N-type metal-oxide-semiconductor (NMOS) switch; however, it should be noted that a variety of other suitable types of switching devices may be used in place of the NMOS switch. In any case, when the switch 86 is closed, or when a gate of the switch 86 receives a voltage that is greater than some threshold, the current-limiting resistor 84 may be shorted or effectively removed from the current-limiting circuit 80 due to the conduction path provided by the switch 86. That is, at this point, the current-limiting resistor 84 is bypassed by the switch 86 and the capacitor 82 is fully charged to the input supply potential. As such, the reduced filtering effectiveness of the capacitor 82 that occurs due to the presence of the current-limiting resistor 84 is limited to a period of time in which the switch 86 is open. After the switch 86 is closed, however, the capacitor 82 shunts any AC current output by the application circuit 90, while providing just a slight degradation on its equivalent series resistance (ESR) due to the ON resistance (e.g., ˜10 mΩ) of the switch 86.

To control the operation of the switch 86 such that the current-limiting resistor 84 is bypassed after the in-rush current has passed, the RC circuit 88 may be coupled to the gate of the switch 86 and designed to provide a threshold voltage to the gate after the in-rush current has passed. As such, the RC circuit 88 determines when to switch the switch 86 on and off. With this in mind, the RC circuit 88 of resistor 90 and capacitor 94 may be designed to have a time constant τ₁ that is larger than a time constant τ₀ associated with the current-limiting resistor 84 and the capacitor 82 circuit to ensure that the in-rush current event has passed. That is, the resistance and capacitance values of the RC circuit 88 may be selected such that the voltage at the capacitor 94 of the RC circuit 88 does not exceed the threshold voltage of the switch 86 until the in-rush current event associated with the capacitor 82 has ended.

The RC circuit 88 may also be sized such that the voltage of the gate of the switch 86 may not exceed the threshold voltage until the capacitor 82 is charged at or above 85%, 90%, 95%, or the like. At this time, the in-rush current event has likely passed and the capacitor 82 may be effectively used to improve a quality of voltage output by the application circuit 90. As such, the time period for the RC circuit 88 to output the threshold voltage to the gate of the switch 86 may be designed to be, for example, between 3τ₀ and 5τ₀. The time period for the RC circuit 88 to output the threshold voltage to the gate of the switch 86 may be designed to be greater than 2τ₀, 3τ₀, or any other suitable time that may correspond to when the in-rush current event has likely passed. Although the RC circuit 88 is described above as operating based on a certain percent charge of the capacitor 82 or designed using a range of time constants, it should be noted that the values described herein are subject to tolerances and should be not be limited to the values presented herein.

With the foregoing in mind, a non-limiting example related to the design of RC circuit 88 is provided below for reference. A 5V USB Type-C adapter (V₁=5V) may desire an in-rush current to be limited to less than 10 mA. As such, the current-limiting resistor 84 (R1) may be sized as follows:

-ti R1=5V/10 mA=500Ω

If the capacitor 82 (C0) is a 47 μF capacitor, the time constant τ₀ for the current-limiting resistor 84 and the capacitor 82 circuit is determined as follows:

τ₀=(C0) R1=47 μF·500Ω=23.5 ms

With this in mind, the RC circuit 88, which is used to control the gate of the switch 86, may then be sized such that the gate of the switch 86 does not reach its threshold voltage prior to the capacitor 82 from being charged to some value (e.g., 95%). Assuming that the value is 95% charge of the capacitor 82, the time constant τ₁ of the RC circuit 88 may be calculated to be 3τ₀. Moreover, assuming that the threshold voltage is 0.9V (V₀=0.9V), the time constant τ₁ of the RC circuit 88 may be calculated as follows:

$${τ}_{1} = ln ( 1 - \frac{{V}_{0}}{{V}_{1}} ) t = ln ( 1 - \frac{0.9 V}{5 V} ) 74 ms = 330 ms$$

Accordingly, the resistance (R2) and the capacitance (C1) of the RC circuit 88 may be selected as R2=150 kΩ and C1=2.2 μF, thereby yielding a time constant τ₁ of 330 ms as shown below.

τ₁=R2*C1=150 lΩ*2.2 μF=330 ms

It should be noted that the resistance value R1 for the current-limiting resistor 84, the time constant τ₀ for the current-limiting resistor 84 and the capacitor 82 circuit, and the time constant τ₁ of the RC circuit 88 calculated in the example provided above are minimum values. As such, when designing the RC circuit 88, it should be understood that the current-limiting resistor 84, the resistance (R2) of the RC circuit 88, and the capacitance (C1) of the RC circuit 88 may be sized to be greater than the values determined using the calculations provided above.

A simulation example of the behavior of the current-limiting circuitry 80 is shown on FIG. 7. Referring now to FIG. 7, curve 102 corresponds to an in-rush current output via the current-limiting circuit 80 when voltage is output via the electrical nodes 92. The voltage at the electrical nodes 92 is depicted with curve 104. As shown in FIG. 7, the curve 102 or the in-rush current is limited to a peak of 10 mA. At the same time the in-rush current peaks, the voltage across the capacitor 82 begins to decline, as indicated by curve 106.

Moreover, after the voltage is output via the electrical nodes 92, the voltage across the capacitor 94 (C1) increases according to curve 108. As the voltage across the capacitor 94 increases, the voltage across the capacitor 94 will eventually reach the threshold voltage (e.g., 0.9V) of the gate of the switch 86. As such, at time T₁, the switch 86 may close and thus the current-limiting resistor 84 may be effectively removed from the current-limiting circuit 80. After the switch 86 closes, the capacitor 82 becomes fully charged and may thus cause a slight increase in in-rush current 109 as shown in the curve 102 after time T₁.

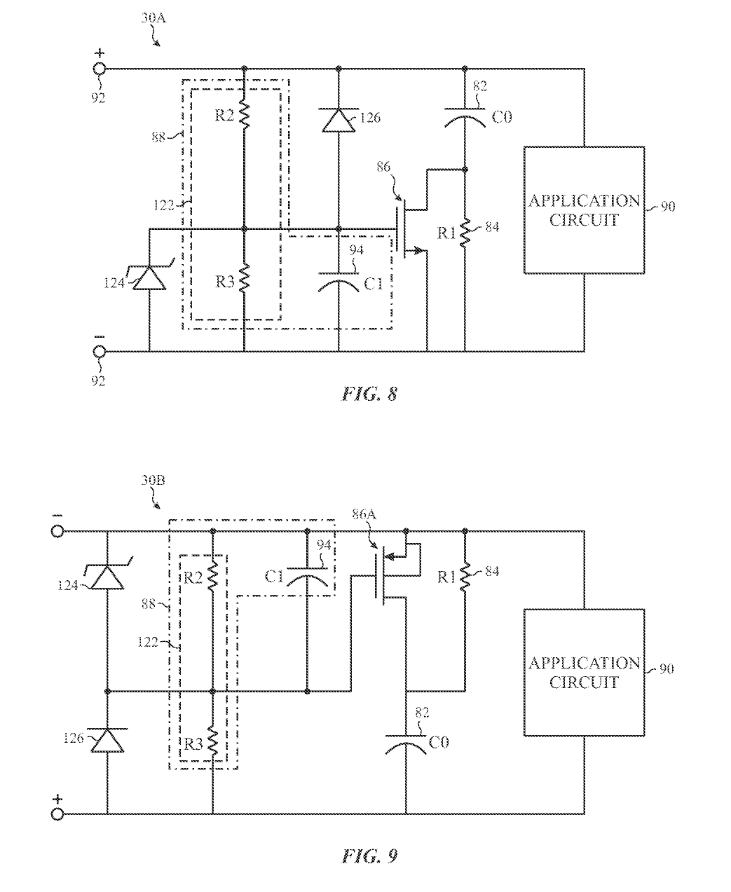

Although the RC circuit 88 described above may be used to activate and deactivate the switch 86, other types of circuits may be used as well. For example, the current-limiting circuit described above may be implemented using a voltage divider and diodes used to dissipate stored energy of the capacitor 94. For example, FIG. 8 illustrates a schematic diagram of a current-limiting circuit 30A that may be employed at the I/O ports 12 of the electronic device 10. As shown in FIG. 8, the current-limiting circuit 30A may be similar to the current-limiting circuit 30 described above except that the RC circuit 88 used to control the gate of the switch 86 may instead include a voltage divider 122, zener diode 124, and diode 126. The voltage divider 122 may be used in combination with the capacitor 94 to control the switch 86 similar as described above with regard to the RC circuit 88. That is, the voltage divider 122 may reduce the voltage provided to the gate of the bypass switch 86 via the RC circuit 88. As such, the current-limiting circuitry 30A may use different capacitance value for the capacitor 94 and a different type of bypass switch 86, as compared to the current-limiting circuitry 30.

The zener diode 124 may limit a gate voltage provided to the switch 86. That is, the zener diode 124 may serve as a voltage clamp for the gate of the switch 86 to ensure that the gate-to-source voltage rating of the switch 86 is not exceeded. The diode 126 may dissipate power or current stored in the capacitor 94 and the capacitor 82 after the application circuit 90 stops outputting power or after a USB device disconnects from the electrical nodes 90. That is, the diode may provide a path for current dissipating from the capacitor 82 to flow, thereby discharging the capacitor 82.

With the foregoing in mind, when the application circuit 90 outputs a voltage and a device is initially coupled to the electrical nodes 92, the voltage provided to the capacitor 94 of the RC circuit 88 may be reduced according to the resistance values of the voltage divider 88. Generally, the RC circuit 88 may eventually output a voltage to the gate of the bypass switch 86 after a certain amount of time passes, such that the in-rush current output by the capacitor 82 has likely passed. As a protective feature to limit the voltage provided to the gate of the switch 86, the zener diode 124 may limit the voltage output by the voltage divider 122. Later, when the device is disconnected from the electrical nodes 92 or when the application circuit 90 stops outputting voltage, energy stored in the capacitor 82 and the capacitor 94 of the RC circuit 88 may be dissipated throughout the current-limiting circuitry 30A via the diode 126.

Although FIGS. 6-8 have been described with reference to using a NMOS-type switch, it should be noted that the current-limiting circuit 30 may also be implemented using a P-type metal-oxide-semiconductor (PMOS-type) switch. For example, FIG. 9 illustrates a schematic diagram of a current-limiting circuit 30B that employs a PMOS-type switch 86A in accordance with embodiments presented herein. The current-limiting circuit 30B operates in the same manner as the current-limiting circuit 30 except that the polarity of the threshold voltage used to activate the switch 86A is reversed. In addition to the components depicted in the schematic diagram of the current-limiting circuit 30B, it should be noted that the zener diode 124 and the power dissipating diode 126 may also be added to the current-limiting circuit 30B, as described above with reference to FIG. 8.

It should be noted that the individual components (e.g., resistors R1, R2, R3, capacitor C1, RC circuit 88) of the current-limiting circuit 30, the current-limiting circuit 30A, and the current-limiting circuit 30B are not limited to the components described herein. Instead, other suitable components may be used to perform the same or similar functions of the components described with respect to FIGS. 6-9. Additionally, it should be noted that control mechanisms other than those described above may be employed to open and close the switch. For example, a comparator circuit may be used to control the operation of the switch 86 based on a detected current or voltage when the in-rush current is expected to have passed or when the capacitor 82 has charged to some level (e.g., 95%). Additionally, a processor may detect a voltage of the capacitor 82 and send a command to the switch 86 to close after the capacitor 82 charges to some level.

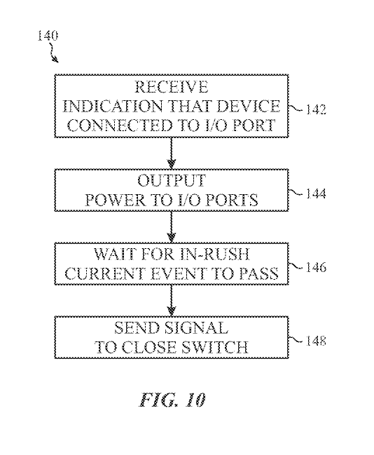

Regardless of the technology used to control the operation of the switch 86 of the current-limiting circuit 30, FIG. 10 illustrates a flow chart of a method 140 that may be employed by some the embodiments of the current-limiting circuit 30 described above. Referring now to FIG. 10, at block 142, the current-limiting circuit 30 may receive an indication that a device (e.g., USB-type device) has connected to the I/O ports 12 (e.g., via the electrical nodes 92). After receiving this indication, the current-limiting circuit 30 may output a voltage to the electrical nodes 92 at block 144. In one embodiment, the current-limiting circuit 30 may output the voltage via the application circuit 90.

At block 146, the current-limiting circuit 30 may wait for an in-rush current event to pass. That is, the current-limiting circuit 30 may use, for example, the RC circuit 88 to provide a threshold voltage to the gate of the switch 86 after an amount of time for the in-rush current event has passed. As discussed above, this amount of time may correspond to 3 to 5 times the time constant τ₀ associated with the capacitor 82 and the current-limiting resistor 84, an amount of time to charge the capacitor 82 to some level, or the like. After the in-rush current event has passed, the current-limiting circuit 30 may, at block 148, send a signal to close the switch 86, thereby bypassing the current-limiting resistor 84 from the current-limiting circuit 30. As a result, the current-limiting resistor 84 may effectively limit the in-rush current to some maximum value and the capacitor 82 may be no longer be inhibited by the presence of the current-limiting resistor 84 after the in-rush current event has passed.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A circuit, comprising:
a port configured to receive a device;
a first capacitor coupled to the port;
a first resistor coupled in series with the first capacitor; and
a switch coupled in parallel with the first resistor, wherein the switch is configured to close after an in-rush current event has passed, thereby bypassing the first resistor.

2. The circuit of claim 1, wherein the device comprises a Universal Serial Bus (USB) device.

3. The circuit of claim 2, wherein the USB device comprises a USB 1.0 device, a USB 2.0 device, a USB 3.0 device, or a USB 3.1 device.

4. The circuit of claim 1, comprising an application circuit configured to output a voltage to the port.

5. The circuit of claim 4, wherein the application circuit comprises a direct current to direct current (DC-to-DC) converter.

6. The circuit of claim 1, wherein the first capacitor is configured to shunt alternating current output by the application circuit.

7. The circuit of claim 1, wherein the first resistor is configured to limit an in-rush current of the in-rush current event to less than 100 mA.

8. The circuit of claim 1, wherein the switch comprises an N-type metal-oxide-semiconductor switch or a P-type metal-oxide-semiconductor switch.

9. The circuit of claim 1, comprising a resistor-capacitor (RC) circuit coupled to the port and to a gate of the switch, wherein the RC circuit is configured to provide a threshold voltage to the gate of the switch after the in-rush current event has passed, thereby causing the switch to close.

10. The circuit of claim 9, wherein the RC circuit comprises a first time constant that is 3 to 5 times a second time constant associated with the first capacitor and the first resistor.

11. The circuit of claim 1, wherein the switch is configured to close after the first capacitor charges to 95%.

12. An electronic device, comprising:
an input/output (I/O) port configured to receive a variety of types of Universal Serial Bus (USB) devices;
a first circuit configured to output a direct current (DC) voltage via the I/O port;
a first capacitor configured to shunt alternating current (AC) noise output by the first circuit;
a second circuit configured to limit an in-rush current from being output via the I/O port, wherein the second circuit comprises:
a resistor coupled in series with the first capacitor; and
a switch coupled in parallel with the resistor.

13. The electronic device of claim 12, comprising a resistor-capacitor (RC) circuit coupled to the I/O port and to a gate of the switch.

14. The electronic device of claim 13, wherein the RC circuit is configured to output a voltage that exceeds a threshold of the gate of the switch before the first capacitor is fully charged.

15. The electronic device of claim 13, wherein a first time constant associated with the first capacitor and the first resistor is less than a second time constant associated with the RC circuit.

16. The electronic device of claim 13, comprising a zener diode coupled in parallel with a second capacitor of the RC circuit.

17. The electronic device of claim 12, comprising a diode coupled in series with the first capacitor, wherein the diode is configured to discharge the first capacitor when a USB device is disconnected from the I/P port.

18. A method, comprising:
receiving, via circuitry, an indication that a device is coupled to a port configured to output a direct current (DC) voltage;
outputting, via the circuitry, the DC voltage via the port;
limiting, via the circuitry, a current output via the port using a resistor of the circuitry; and
bypassing, via the circuitry, the resistor from the circuitry after an amount of time expires.

19. The method of claim 18, wherein the amount of time corresponds to when a capacitor of the circuitry is charged to a value, wherein the capacitor is configured to filter alternating current (AC) noise from the DC voltage.

20. The method of claim 18, wherein shunting the resistor from the circuitry comprises closing a switch of the circuitry, wherein the switch is coupled in parallel with the resistor.
